(19) United States
(12) Patent Application Publication
(10) Pub. No.: US 2025/0237976 A1
(43) Pub. Date: Jul. 24, 2025

(54) DEVELOPMENT DEVICE

(71) Applicant: CANON KABUSHIKI KAISHA, Tokyo (JP)

(72) Inventors: CHIHIRO TANAKA, Chiba (JP); NAONARI HASHIMURA, Chiba (JP); SATORU SEKIKAWA, Tokyo (JP); KOJI SHIGEHIRO, Tokyo (JP); TOSHIYA FUKAZAWA, Chiba (JP); SATOSHI NAWA, Chiba (JP); RENA TAKAHASHI, Kanagawa (JP)

(21) Appl. No.: 19/033,207

(22) Filed: Jan. 21, 2025

(30) Foreign Application Priority Data
Jan. 23, 2024 (JP) 2024-007816

(51) Int. Cl. G03G 15/09

(52) U.S. Cl. CPC G03G 15/0942; G03G 15/0921

(57) ABSTRACT

A development device includes a first sheet that is fixed to the cover, the first sheet being arranged to contact a magnetic brush, and a second sheet that is fixed to the cover, the second sheet being arranged to be superimposed on a first surface of the first sheet. With respect to the rotational direction of the developing rotation member, a free end of the first sheet is disposed on a downstream of a position where the regulating portion opposes the developing rotation member and on an upstream of the closest portion between the developing rotation member and the image bearing member. With respect to the rotational direction of the developing rotation member, a free end of the second sheet is disposed on the downstream of the position where the regulating portion opposes the developing rotation member and on an upstream of the free end of the first sheet.

### BACKGROUND

### Field

The present disclosure relates to a development device that develops an electrostatic latent image formed on an image bearing member by using a developer containing toner and a carrier.

### Description of the Related Art

In an image forming apparatus using an electrophotographic method or the like, a development device develops an electrostatic latent image, which has been formed on a photosensitive drum (an image bearing member), into a toner image. As such a development device, a development device that uses a two-component developer containing toner and a carrier has been conventionally used.

The development device includes: a developer container that accommodates the developer containing the toner and the carrier; a rotatable developing sleeve (a developing rotation member) that bears the developer to develop the electrostatic latent image formed on the photosensitive drum; and a regulating blade that regulates an amount of the developer borne by the developing sleeve.

The developer is conveyed to a development region where the electrostatic latent image is developed by the developing sleeve. The thus-conveyed developer then forms a magnetic brush by raising naps in the development region. Thereafter, the toner in the developer is supplied from the magnetic brush in the development region to the electrostatic latent image. In this way, the electrostatic latent image is developed as the toner image. Meanwhile, some of the toner in the developer, which has been supplied from the magnetic brush in the development region, may not adhere to the electrostatic latent image in the development region, and may scatter from the development region.

The following development device having a flexible member is discussed in Japanese Patent Application Laid-Open No. 2006-221132. The flexible member abuts a developer on a developing sleeve in a first region where the developer on the developing sleeve bristles. In addition, the flexible member is in close proximity to the developing sleeve in a second region where the developer on the developing sleeve does not bristle.

In the configuration discussed in Japanese Patent Application Laid-Open No. 2006-221132, the flexible member abuts the developer in the first region where the developer on the developing sleeve bristles. Thus, even when toner adheres to an opposing surface of the flexible member that opposes the developing sleeve, the toner that has adhered to the opposing surface can be removed by the bristling developer.

However, as in the configuration discussed in Japanese Patent Application Laid-Open No. 2006-221132, in a case where the flexible member abuts the developer in the first region where the developer on the developing sleeve bristles, the flexible member is possibly lifted by the bristling developer, and a distal end of the flexible member is possibly floated from the developing sleeve.

In a case where the development device continues to be operated while the distal end of the flexible member is floated from the developing sleeve, the toner that has scattered is accumulated on the distal end of the flexible member. Thereafter, when a certain amount of the toner is accumulated on the distal end of the flexible member, the accumulated toner may collapse due to own weight and be dropped on a photosensitive drum. As a result, an image defect that is caused by toner contamination called toner dripping possibly occurs on the image.

### SUMMARY

The present disclosure is directed to suppression of occurrence of image failure.

According to some embodiments, a development device includes a developer container configured to accommodate a developer containing toner and a carrier, a developing rotation member configured to bear and convey the developer in order to develop an electrostatic latent image formed on an image bearing member, a magnet that is fixed in a non-rotatable manner in the developing rotation member, the magnet having a first magnetic pole and a second magnetic pole, the first magnetic pole being arranged in a closest portion between the developing rotation member and the image bearing member, the second magnetic pole being arranged on an upstream of the first magnetic pole in a rotational direction of the developing rotation member, being adjacent to the first magnetic pole, and being a different pole from the first magnetic pole, a regulating portion that is provided to oppose the developing rotation member in a non-contact manner and regulates an amount of the developer borne by the developing rotation member, a cover that is provided to oppose the developing rotation member in a non-contact manner and cover the developing rotation member, a first sheet that is fixed to the cover, the first sheet being arranged to contact a magnetic brush of the developer that is borne by the developing rotation member, and a second sheet that is fixed to the cover, at least at a maximum peak position of magnetic flux density of the second magnetic pole in a normal direction with respect to an outer circumferential surface of the developing rotation member, the second sheet being arranged to be superimposed on a first surface of the first sheet that is a surface on an opposite side to a second surface of the first sheet, and the second surface of the first sheet being a surface on a side of contacting the magnetic brush of the developer that is borne by the developing rotation member. With respect to the rotational direction of the developing rotation member, a free end of the first sheet is disposed on a downstream of a position where the regulating portion opposes the developing rotation member and on an upstream of the closest portion between the developing rotation member and the image bearing member. With respect to the rotational direction of the developing rotation member, a free end of the second sheet is disposed on the downstream of the position where the regulating portion opposes the developing rotation member and on an upstream of the free end of the first sheet.

According to another aspect of the present disclosure, a development device includes a developer container configured to accommodate a developer containing toner and a carrier, a developing rotation member configured to bear and convey the developer in order to develop an electrostatic latent image formed on an image bearing member, a magnet that is fixed in a non-rotatable manner in the developing rotation member, the magnet having a first magnetic pole and a second magnetic pole, the first magnetic pole being arranged in a closest portion between the developing rotation member and the image bearing member, the second magnetic pole being arranged on an upstream of the first magnetic pole in a rotational direction of the developing rotation member, being adjacent to the first magnetic pole, and being a different pole from the first magnetic pole, a regulating portion that is provided to oppose the developing rotation member in a non-contact manner and regulates an amount of the developer borne by the developing rotation member, a cover that is provided to oppose the developing rotation member in a non-contact manner and cover the developing rotation member, and a sheet that is fixed to the cover, the sheet being arranged to contact a magnetic brush of the developer that is borne by the developing rotation member. Stiffness of the sheet at a maximum peak position of magnetic flux density of the second magnetic pole in a normal direction with respect to an outer circumferential surface of the developing rotation member is higher than stiffness of the sheet at a free end of the sheet.

According to still another aspect of the present disclosure, a development device includes a developer container configured to accommodate a developer containing toner and a carrier, a developing rotation member configured to bear and convey the developer in order to develop an electrostatic latent image formed on an image bearing member, a magnet that is fixed in a non-rotatable manner in the developing rotation member, the magnet having a first magnetic pole and a second magnetic pole, the first magnetic pole being arranged in a closest portion between the developing rotation member and the image bearing member, and the second magnetic pole being arranged on an upstream of the first magnetic pole in a rotational direction of the developing rotation member, being adjacent to the first magnetic pole, and being a different pole from the first magnetic pole, a regulating portion that is provided to oppose the developing rotation member in a non-contact manner and regulates an amount of the developer borne by the developing rotation member, a cover that is provided to oppose the developing rotation member in a non-contact manner and covers the developing rotation member, and a sheet that is fixed to the cover, the sheet being arranged to contact a magnetic brush of the developer that is borne by the developing rotation member. A thickness of the sheet at a maximum peak position of magnetic flux density of the second magnetic pole in a normal direction with respect to an outer circumferential surface of the developing rotation member is greater than a thickness of the sheet at a free end of the sheet.

Further features of the present disclosure will become apparent from the following description of exemplary embodiments with reference to the attached drawings.

### BRIEF DESCRIPTION OF THE DRAWINGS

FIG. 1 is a cross-sectional view illustrating a configuration of an image forming apparatus according to a first exemplary embodiment.

FIG. 2 is a cross-sectional view illustrating a configuration of a development device according to the first exemplary embodiment.

FIG. 3 is a cross-sectional view (an enlarged view) illustrating a configuration around developing sleeves according to the first exemplary embodiment.

FIG. 4 is a cross-sectional view (an enlarged view) illustrating a configuration around a developing sleeve cover according to the first exemplary embodiment.

FIG. 5 is a cross-sectional view (an enlarged view) illustrating a configuration around a developing sleeve cover according to a second exemplary embodiment.

FIG. 6 is a cross-sectional view illustrating a configuration of a development device in a conventional example.

FIG. 7 is a cross-sectional view (an enlarged view) illustrating a configuration around a developing sleeve cover in the conventional example.

FIG. 8 is a cross-sectional view (an enlarged view) illustrating the configuration around the developing sleeve cover in the conventional example.

### DESCRIPTION OF THE EMBODIMENTS

Hereinafter, a detailed description will be made on exemplary embodiments of the present disclosure with reference to the accompanying drawings. It is noted that the following exemplary embodiments do not limit the present disclosure according to the claims, and all combinations of features described in a first exemplary embodiment are not necessarily essential to means to solve the issues of the present disclosure. The present disclosure can be implemented in various applications such as printers, various types of printing machines, copiers, facsimiles, multi-function peripherals (MFPs).

### (Configuration of Image Forming Apparatus)

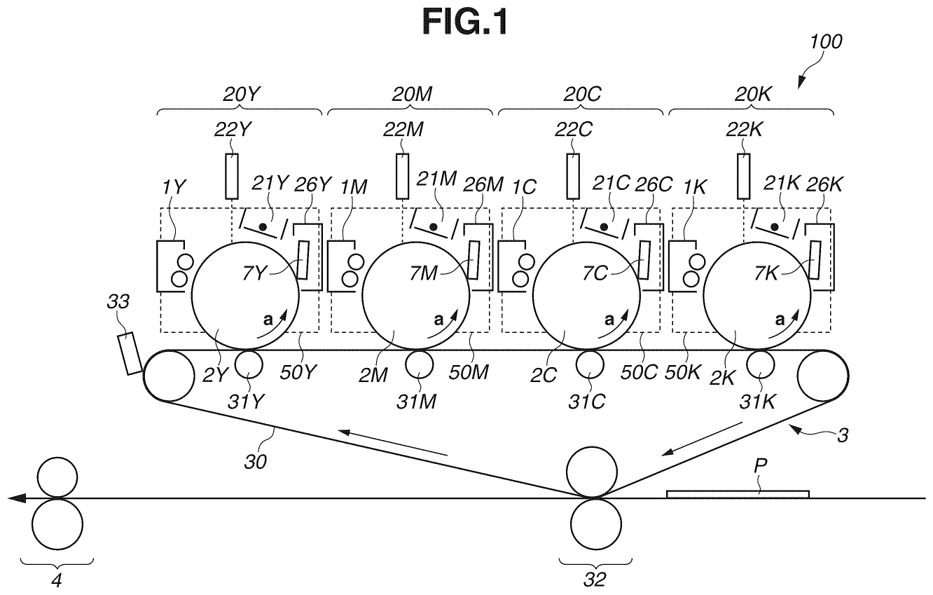

First, a description will be made on a configuration and operation of an entire image forming apparatus with reference to FIG. 1. FIG. 1 is a cross-sectional view illustrating a configuration of an image forming apparatus 100 according to the first exemplary embodiment.

The image forming apparatus 100 is a full-color image forming apparatus. In the first exemplary embodiment, the image forming apparatus 100 is an MFP that has a copying function, a printing function, and a scanning function, for example.

As illustrated in FIG. 1, the image forming apparatus 100 has image forming sections 20Y, 20M, 20C, 20K in parallel. The image forming sections 20Y, 20M, 20C, 20K perform an image formation process of a toner image in four colors that are yellow (Y), magenta (M), cyan (C), and black (K), respectively. The image forming sections 20Y, 20M, 20C, 20K in the respective colors have chargers 21Y, 21M, 21C, 21K and development devices 1Y, 1M, 1C, 1K, respectively. The image forming sections 20Y, 20M, 20C, 20K in the respective colors also have exposure devices 22Y, 22M, 22C, 22K, photosensitive drums 2Y, 2M, 2C, 2K, and cleaning devices 26Y, 26M, 26C, 26K. The image forming apparatus 100 further has a transfer device 3 and a fixing device 4.

Here, the image forming sections 20Y, 20M, 20C, 20K in the respective colors have the same configuration. Accordingly, a description will hereinafter be made by using an image forming apparatus, each component of which is denoted by a reference sign without the last character Y, M, C, or K indicating color distinguishment of the image forming sections 20Y, 20M, 20C, 20K.

The photosensitive drum 2 (an image bearing member) is provided to be rotatable, and rotates in an arrow a direction at a process speed of 630 mm/sec. A surface of the photosensitive drum 2 is charged uniformly by the charger 21, is then exposed to light that has been modulated by an exposure device 22 (an optical writing device), such as laser, in accordance with an information signal, and is thereby formed with a latent image (an electrostatic latent image).

The development device 1 visualizes the electrostatic latent image formed on the surface of the photosensitive drum 2 in a process as will be described below. In a primary transfer section 31 that is provided to each station, the visible toner image is transferred onto a transfer belt 30 that constitutes the transfer device 3. The toner image that has been transferred onto the transfer belt 30 is conveyed to a secondary transfer section 32.

Thereafter, the toner image that has been conveyed to the secondary transfer section 32 is transferred onto a sheet P as a recording material. The fixing device 4 then fixes the toner image onto the sheet P, and an image is thereby obtained.

The transfer residual toner on the photosensitive drum 2 and the residual toner on the transfer belt 30 after the transfer are removed by the cleaning devices 26, 33, respectively. The toner contained in the developer is replenished together with a carrier from a toner cartridge by an amount that has been consumed for image formation.

### (Configuration of Development Device)

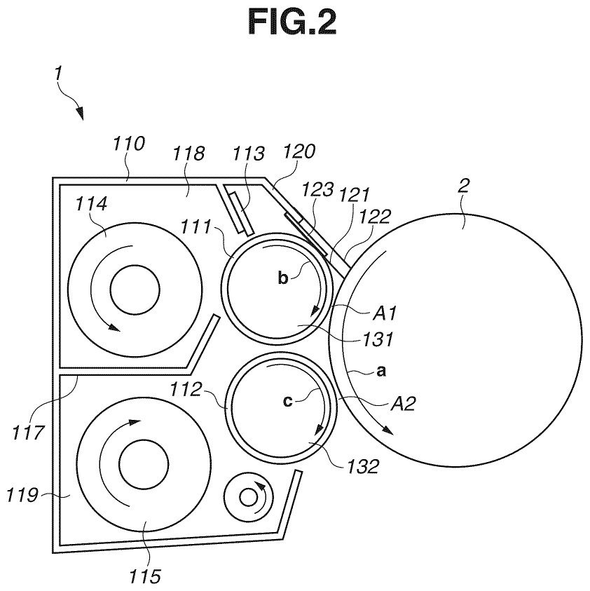

Next, a description will be made on a configuration and operation of the development device according to the first exemplary embodiment with reference to FIG. 2. FIG. 2 is a cross-sectional view illustrating a configuration of the development device 1 according to the first exemplary embodiment.

The development device 1 includes a developer container 110 that accommodates a two-component developer (hereinafter simply referred to as the developer) containing the toner and the carrier.

In the first exemplary embodiment, non-magnetic toner particles (the toner) and magnetic carrier particles (the carrier) are used as the developer. The non-magnetic toner particles are colored resin particles, each of which contains a binder resin, a colorant, and, when desired, other additives. An external additive, such as colloidal silica fine powder, is added to a surface of each of the non-magnetic toner particles.

The non-magnetic toner particles used in the first exemplary embodiment are formed from a negatively chargeable polyester resin, and a volume average particle diameter thereof is approximately from 4 micrometers (μm) to 8 μm. The magnetic carrier particles are, for example, magnetic metal particles of iron, nickel, cobalt, or the like, each of which has an oxidized surface, and a volume average particle diameter is approximately 40 μm.

In the developer container 110, a partition wall 117 extends in a perpendicular direction of the sheet substantially at a center of the inside of the developer container 110. The partition wall 117 vertically partitions the developer container 110 into a development chamber 118 and an agitating chamber 119. The developer in which the toner and the magnetic carrier are mixed is accommodated in the development chamber 118 and the agitating chamber 119.

In the development chamber 118 and the agitating chamber 119, a first conveying screw 114 and a second conveying screw 115 are arranged, respectively. The first conveying screw 114 and the second conveying screw 115 are circulation units, each of which agitates and conveys the developer and circulates the developer within the developer container 110.

The first conveying screw 114 is arranged substantially parallel to a rotational axis direction of a rotatable developing sleeve (a developing rotation member) at a bottom portion of the development chamber 118. When the first conveying screw 114 is rotationally driven, the developer in the development chamber 118 is conveyed in one direction along a rotational axis direction of the first conveying screw 114. Meanwhile, the second conveying screw 115 is arranged substantially parallel to the first conveying screw 114 at a bottom portion of the agitating chamber 119. When the second conveying screw 115 is rotationally driven, the developer in the agitating chamber 119 is conveyed in an opposite direction from the direction of the first conveying screw 114.

The developer, which has been conveyed by the rotation of the first conveying screw 114 and the second conveying screw 115 just as described, is circulated between the development chamber 118 and the agitating chamber 119 through openings (communication sections) at both ends of the partition wall 117.

The developer in the development chamber 118 is configured such that the developer is supplied from the opening between a regulating blade (a regulating portion) 113 and the partition wall 117 by rotational driving of the first conveying screw 114. The first conveying screw 114 and the second conveying screw 115 each adopt a screw structure in which agitating blades formed of a non-magnetic material are spirally provided about a rotation shaft. Screw diameters are all φ20 mm, a screw pitch is 30 mm, and the number of rotations is set to 630 rpm.

In the developer container 110, a portion near the photosensitive drum 2 has an opening. The developer container 110 has two developer bearing members that are an upstream developing sleeve 111 (a first developer bearing member) and a downstream developing sleeve 112 (a second developer bearing member). Each of the upstream developing sleeve 111 and the downstream developing sleeve 112 is 1 mm in thickness, 25 mm in outer diameter, and 350 mm in length in a thrust direction. In addition, a gap (an SD gap) between the upstream developing sleeve 111 and the photosensitive drum 2 is set to approximately 270 μm, and a gap (an SD gap) between the downstream developing sleeve 112 and the photosensitive drum 2 is set to approximately 450 μm.

In the upstream developing sleeve 111, a first magnet roller 131 (a first magnet as a first magnetic field generation member) in a roller shape is fixed in a non-rotatable manner. The upstream developing sleeve 111 rotates in an arrow b direction at a peripheral-speed ratio of 140% with respect to the photosensitive drum 2 and thereby bears and conveys the developer. In an opposing portion between the upstream developing sleeve 111 and the photosensitive drum 2 (hereinafter referred to as a first development region A1), a rotational direction of the upstream developing sleeve 111 (the arrow b direction) is the same as a rotational direction of the photosensitive drum 2 (an arrow a direction).

On an upstream side of the first development region A1 in the rotational direction of the upstream developing sleeve 111 (the arrow b direction), the regulating blade 113 is arranged above the upstream developing sleeve 111 and opposes the upstream developing sleeve 111 in a non-contact manner. With this configuration, the regulating blade 113 regulates a layer thickness of the developer, which has been accommodated in the development chamber 118 and supplied to the upstream developing sleeve 111 by the first conveying screw 114. In the first exemplary embodiment, the regulating blade 113 regulates a developer coating amount per unit area on the upstream developing sleeve 111 to 30 mg/cm² (milligrams per square centimeter).

In the first magnet roller 131, a magnetic pole N1 (a pumping pole) is formed near the regulating blade 113. The regulating blade 113 regulates the developer, which has been retained by magnetic field lines (a magnetic force or a magnetic field) generated by the magnetic pole N1, to have the appropriate layer thickness. Thereafter, the developer, whose layer thickness has been regulated, is borne and conveyed to the first development region A1.

The first magnet roller 131 also has a magnetic pole S2 (a developing pole) that opposes the first development region A1. The magnetic pole S2 (the developing pole) is arranged in the closest portion between the upstream developing sleeve 111 and the photosensitive drum 2.

Due to a magnetic field that is formed in the first development region A1 by the magnetic pole S2, a magnetic brush of the developer is formed on the first magnet roller 131. In the first development region A1, this magnetic brush comes into contact with the photosensitive drum 2 that rotates in the arrow a direction.

Consequently, the electrostatic latent image on the photosensitive drum 2 is developed in the first development region A1, and thereby becomes the toner image. This is the first development by the development device 1. At this time, the toner that adheres to the magnetic brush and the toner that adheres to a surface of the upstream developing sleeve 111 are transferred to an image region of the electrostatic latent image on the photosensitive drum 2 to develop the electrostatic latent image.

In the first exemplary embodiment, the first magnet roller 131 has five poles that are the magnetic pole S2 (the developing pole), the magnetic pole N1 (the pumping pole), a magnetic pole S1 (a conveying pole), a magnetic pole N2 (a conveying pole), and a magnetic pole N3 (a delivery pole). Of a plurality of the magnetic poles formed in the first magnet roller 131, the magnetic pole N1 and the magnetic pole N3 have the same polarity and are adjacent to each other. A low magnetic field region (a first repulsive magnetic field region RF1) is formed between the magnetic pole N1 and the magnetic pole N3, and is a region where magnetic flux density is 5 mT (millitesla) or less. In the first repulsive magnetic field region RF1, a barrier is formed against the developer.

The downstream developing sleeve 112 is disposed in a region that is located below the upstream developing sleeve 111 and opposes both the upstream developing sleeve 111 and the photosensitive drum 2. The downstream developing sleeve 112 is disposed to be rotatable in an arrow c direction at a peripheral-speed ratio of 140% with respect to the photosensitive drum 2. Similarly to the upstream developing sleeve 111, the downstream developing sleeve 112 is formed of a non-magnetic material.

In the downstream developing sleeve 112, a second magnet roller 132 (a second magnet as a second magnetic field generation member) in a roller shape is fixed in a non-rotatable manner. The second magnet roller 132 has five poles that are a magnetic pole S3 (a receiving pole), a magnetic pole N4 (a developing pole), a magnetic pole S4 (a conveying pole), a magnetic pole N5 (a conveying pole), and a magnetic pole S5 (a stripping pole).

Of these poles, a magnetic brush on the magnetic pole N4 is in contact with the photosensitive drum 2 in an opposing portion between the downstream developing sleeve 112 and the photosensitive drum 2 (hereinafter referred to as a second development region A2). Accordingly, in the second development region A2, second development is further performed for the photosensitive drum 2 that has passed the first development region A1. The developer that has been subjected to the second development by the downstream developing sleeve 112 returns to the agitating chamber 119.

Of a plurality of the magnetic poles formed in the second magnet roller 132, the magnetic pole S3 and the magnetic pole S5 have the same polarity. Accordingly, a low magnetic field region (a second repulsive magnetic field region RF2) is formed between the magnetic pole S3 and the magnetic pole S4, and the low magnetic field region is a region where the magnetic flux density is 5 mT or less. In the second repulsive magnetic field region RF2, a barrier is formed against the developer.

The magnetic pole S3 (the receiving pole) of the second magnet roller 132 opposes the magnetic pole N3 (the delivery pole) of the first magnet roller 131 at a position where the upstream developing sleeve 111 and the downstream developing sleeve 112 are closest to each other. The polarity of the magnetic pole S3 of the second magnet roller 132 differs from that of the magnetic pole N3 of the first magnet roller 131. Accordingly, magnetic field lines are formed between the magnetic pole N3 of the first magnet roller 131 and the magnetic pole S3 of the second magnet roller 132, and the developer is transferred from the first magnet roller 131 to the second magnet roller 132 by the magnetic field lines.

At the position where the upstream developing sleeve 111 and the downstream developing sleeve 112 are closest to each other, a rotational direction of the downstream developing sleeve 112 (an arrow c direction) is opposite to the rotational direction of the upstream developing sleeve 111 (the arrow b direction).

In a developing bias used in the first exemplary embodiment, an alternating-current (AC) component and a direct-current (DC) component are superimposed. The developing bias application unit applies such a developing bias to the upstream developing sleeve 111 and the downstream developing sleeve 112. In the first exemplary embodiment, a blank pulse of the DC component is provided by thinning out the AC component intermittently. The number of pulses is set to 8 when the AC component has a rectangular wave of 12 kHz, and a half cycle of the rectangular wave in a blank part is 1 pulse. In addition, a ratio between an electric field on a developing side and an electric field on a collecting side (hereinafter, duty) is set to 50%.

### (Flow of Developer)

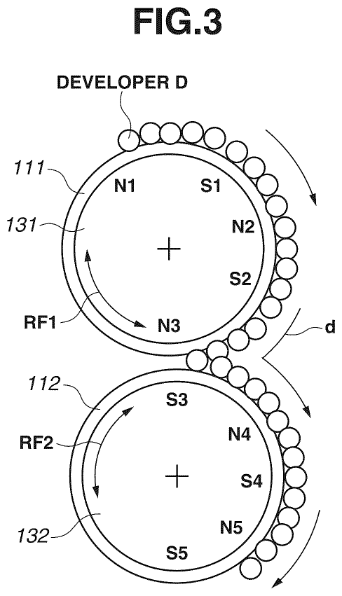

A description will be made on a flow of the developer generated by the above-described configuration with reference to FIG. 3. FIG. 3 is a cross-sectional view (an enlarged view) illustrating a configuration around the developing sleeves according to the first exemplary embodiment.

Since non-magnetic toner and a magnetic carrier are mixed in a developer D, the developer D is restrained by the magnetic pole N1 of the first magnet roller 131. Next, with rotation of the upstream developing sleeve 111, the developer D passes the magnetic pole N1 that opposes the regulating blade 113, and is thereby regulated to a predetermined amount. The developer D that has been regulated by the regulating blade 113 passes the magnetic pole S1 and the magnetic pole N2 of the first magnet roller 131, and is then supplied to the magnetic pole S2 that opposes the photosensitive drum 2. When the developer D passes through the first development region A1, the toner is supplied to the electrostatic latent image formed on the surface of the photosensitive drum 2. Then, the developer D in which the toner has been consumed is conveyed to the magnetic pole N3 of the first magnet roller 131. Here, the first repulsive magnetic field region RF1 is formed between the magnetic pole N1 and the magnetic pole N3 of the first magnet roller 131. In addition, in the downstream developing sleeve 112, the second repulsive magnetic field region RF2 is formed between the magnetic pole S3 and the magnetic pole S5 of the second magnet roller 132.

Thus, the developer D, which has been conveyed on the upstream developing sleeve 111 as described above and passed through the first development region A1, reaches the magnetic pole N3 of the first magnet roller 131. Meanwhile, the developer D that has passed through the first development region A1 cannot pass through the position where the upstream developing sleeve 111 and the downstream developing sleeve 112 are closest to each other, due to the first repulsive magnetic field region RF1 and the second repulsive magnetic field region RF2.

Then, as indicated by an arrow d, the developer D on the upstream developing sleeve 111 moves to the downstream developing sleeve 112 side along the magnetic field lines that extend in a direction toward the magnetic pole S3 of the second magnet roller 132 from the magnetic pole N3 of the first magnet roller 131. Thereafter, the developer D is conveyed on the downstream developing sleeve 112, passes through the second development region A2, and reaches the magnetic pole S5 of the second magnet roller 132. At the magnetic pole S5, the developer D is stripped away from the downstream developing sleeve 112 due to the second repulsive magnetic field region RF2, and is then conveyed to the second conveying screw 115 in the agitating chamber 119.

In regard to the rotational direction of the upstream developing sleeve 111, the conveyance of the developer may become unstable and cause uneven density in a configuration that the poles (the magnetic pole N2 and the magnetic pole S1 in the first exemplary embodiment) are not provided between the magnetic pole N1 and the magnetic pole S2 of the first magnet roller 131. In order to handle such an issue, in the first exemplary embodiment, the first magnet roller 131 adopts the configuration to provide the magnetic pole S1 and the magnetic pole N2 serving as the conveying poles between the magnetic pole N1 and the magnetic pole S2.

In addition, in regard to the rotational direction of the downstream developing sleeve 112, the conveyance of the developer may become unstable and cause the uneven density in a configuration that the poles (the magnetic pole S4 and the magnetic pole N5 in the first exemplary embodiment) are not provided between the magnetic pole N4 and the magnetic pole S5 in the second magnet roller 132. In order to handle such an issue, in the first exemplary embodiment, the second magnet roller 132 adopts the configuration to provide the magnetic pole S4 and the magnetic pole N5 serving as the conveying poles between the magnetic pole N4 and the magnetic pole S5.

### (Separation of Toner)

The developer D on the developing sleeve is conveyed along the magnetic field lines, each of which extends from each of the magnetic poles to the respective adjacent magnetic pole in the conveyance direction, while formation and falling down of the magnetic brush are alternately repeated. The toner is separated due to a centrifugal force that is generated during the conveyance of the developer D on the developing sleeve, an impact caused by thrashing of the magnetic brush of the developer D along the magnetic field lines, or an impact at the time when the magnetic brush falls down. Such a phenomenon becomes more remarkable as the velocity of rotations of the upstream developing sleeve 111 is increased.

### (Developing Sleeve Cover and Scatter Prevention Sheet)

As illustrated in FIG. 2, in the development device 1 according to the first exemplary embodiment, a developing sleeve cover 120 (a cover section) is provided for the developer container 110. The developing sleeve cover 120 is provided to oppose the upstream developing sleeve 111 in a non-contact manner. The developing sleeve cover 120 is also provided to cover the regulating blade 113 and the developer container 110 from above.

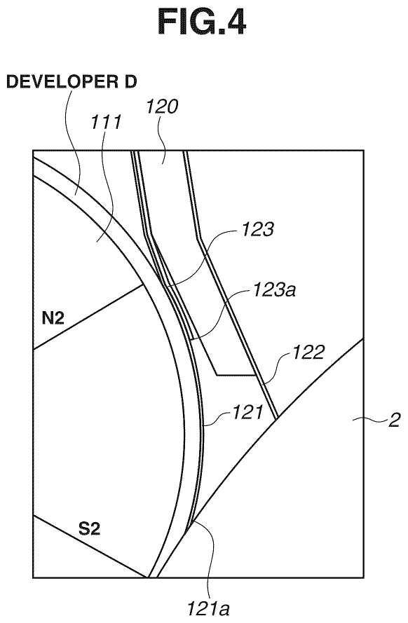

Here, a detailed description will be made on the developing sleeve cover 120 with reference to FIG. 4. FIG. 4 is a cross-sectional view (an enlarged view) illustrating a configuration around the developing sleeve cover according to the first exemplary embodiment.

The developer D, which has been regulated by the regulating blade 113, passes the magnetic pole S1 and the magnetic pole N2 of the first magnet roller 131, and is then conveyed to the magnetic pole S2, which opposes the photosensitive drum 2.

As illustrated in FIG. 4, a first scatter prevention sheet 121 (a first sheet section) is fixed to the developing sleeve cover 120 by an adhesive, a double-sided tape, or the like, and is provided to abut the developer D that bristles at the magnetic pole N2.

In addition, a distal end (a free end 121a) of the first scatter prevention sheet 121 is provided at a position where the distal end (the free end 121a) abuts the photosensitive drum 2 and does not enter the first development region A1. The first scatter prevention sheet 121 is provided over an entire developer coated region (a region with a developer conveyance ability) of the upstream developing sleeve 111 from one end to the other end of the developer coated region in a longitudinal direction. In a case where an outer surface of the developing sleeve is blasted or formed with a groove, a region where such processing has been performed is a region where the developer conveyance ability of the developing sleeve is present.

The first scatter prevention sheet 121 preferably has a low Young's modulus so as to be brought into contact with the developer on the upstream developing sleeve 111 along the developer. In the first exemplary embodiment, the first scatter prevention sheet 121 is formed of a urethane sheet that is approximately 100 μm in thickness.

In the first exemplary embodiment, the first scatter prevention sheet 121 abuts the developer D on the upstream developing sleeve 111. In this way, thrashing of the developer is reduced, and the separation of the toner is suppressed.

In regard to the rotational direction of the upstream developing sleeve 111, it is also necessary to prevent the toner, which has been separated from downstream of the first scatter prevention sheet 121 in the first development region A1, from scattering to an upper portion of the developer container 110 and contaminating other components. For such a reason, in the first exemplary embodiment, the developing sleeve cover 120 has a second scatter prevention sheet 122 (a third sheet section). The second scatter prevention sheet 122 is provided to have a clearance of approximately 2 to 3 mm from the first scatter prevention sheet 121 and abuts the photosensitive drum 2. Similarly to the first scatter prevention sheet 121, the second scatter prevention sheet 122 is formed of the urethane sheet that is approximately 100 μm in thickness.

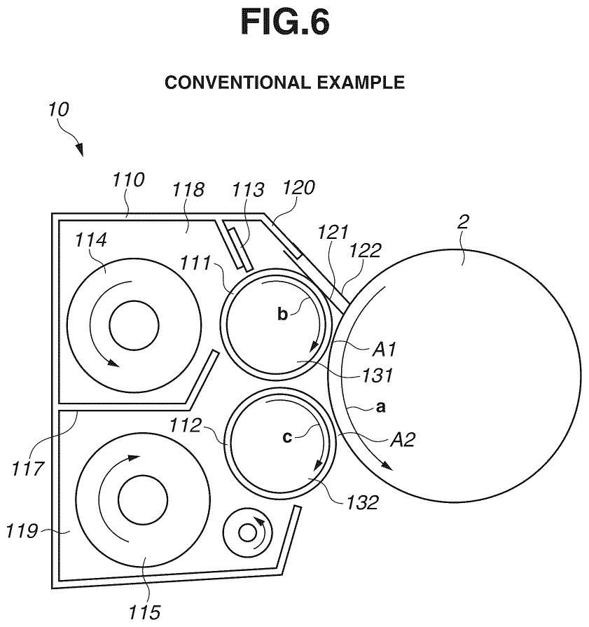

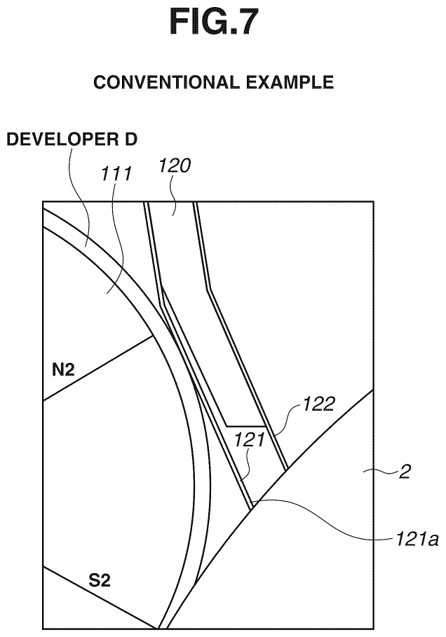

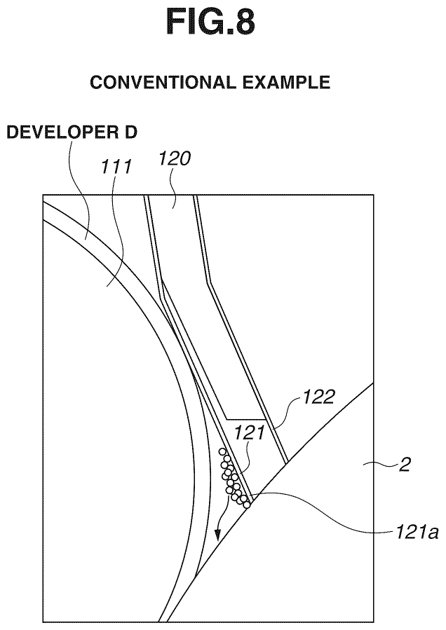

FIG. 6 is a cross-sectional view illustrating a configuration of a development device 10 in a conventional example. FIGS. 7 and 8 are cross-sectional views each illustrating a configuration around a developing sleeve cover in the conventional example. In particular, FIG. 8 schematically illustrates the surroundings of the developing sleeve cover when the developer drips in the conventional example.

As in the conventional example illustrated in FIGS. 6 and 7, it is assumed that the first scatter prevention sheet 121 is arranged to abut the magnetic brush of the developer D on the upstream developing sleeve 111. In such a case, a portion of the first scatter prevention sheet 121 is lifted by the magnetic brush whose contact portion is bristled, as the upstream developing sleeve 111 is rotationally driven.

When the distal end (the free end 121a) of the first scatter prevention sheet 121 remains to be lifted from the upstream developing sleeve 111 by the magnetic brush, the first scatter prevention sheet 121 can no longer be in contact with the developer D on the upstream developing sleeve 111 in a portion in which the magnet brush has fell down.

As a result, the separated toner is accumulated in a region, which is not in contact with the developer D on the upstream developing sleeve 111, in the first scatter prevention sheet 121. In particular, as illustrated in FIG. 8, when a certain amount of the toner is accumulated on the distal end (the free end 121a) of the first scatter prevention sheet 121, a gravitational force overcomes an adhesive force between the toner particles. As a result, a mass of the accumulated toner collapses due to own weight and falls onto the photosensitive drum 2. For this reason, image failure that is caused by toner contamination called dripping possibly occurs on the image.

To handle such an issue, in the first exemplary embodiment, the developing sleeve cover 120 has a backup sheet 123 (a second sheet section) to back up the first scatter prevention sheet 121 in order to prevent deformation of the first scatter prevention sheet 121 by the magnetic brush. In this way, occurrence of the image failure is suppressed in the development device having the sheet section that abuts the developer in the region where the developer on the developing sleeve bristles. Hereinafter, a detailed description thereon will be made.

### (Backup Sheet)

First, a description will be made on a configuration of the developing sleeve cover 120 according to the first exemplary embodiment with reference to FIG. 4. FIG. 4 is the cross-sectional view (the enlarged view) illustrating the configuration around the developing sleeve cover according to the first exemplary embodiment.

The developer D on the upstream developing sleeve 111 is pulled by the magnetic force of the first magnet roller 131 when the upstream developing sleeve 111 is at rest. Thus, the developer D on the upstream developing sleeve 111 is attracted to and borne densely on the surface of the upstream developing sleeve 111. Meanwhile, the centrifugal force is applied when the upstream developing sleeve 111 is rotationally driven. Thus, the magnetic brush extends to a position where the centrifugal force and an attracting force of the magnetic force are balanced. As a result, when the upstream developing sleeve 111 is rotationally driven, the magnetic brush at the magnetic pole N2 of the first magnet roller 131 lifts the first scatter prevention sheet 121.

On the other hand, in the first exemplary embodiment as illustrated in FIG. 4, the backup sheet 123, which backs up the first scatter prevention sheet 121, is fixed to the developing sleeve cover 120 in a manner to cover the magnetic brush at the magnetic pole N2 of the first magnet roller 131. Examples of a unit that fixes the backup sheet 123 to the developing sleeve cover 120 include an adhesive and a double-sided tape.

As illustrated in FIG. 4, the backup sheet 123 is also arranged to be superimposed on an opposite surface (a back surface of the first scatter prevention sheet 121) of the first scatter prevention sheet 121 to a surface (a contact surface of the first scatter prevention sheet 121) on a side where the first scatter prevention sheet 121 is in contact with the upstream developing sleeve 111. In this way, the first scatter prevention sheet 121 is prevented from being lifted when the upstream developing sleeve 111 is rotationally driven.

As described above, the first scatter prevention sheet 121 is provided over the entire developer coated region (the region with the developer conveyance ability) of the upstream developing sleeve 111 from the one end to the other end of the developer coated region in the longitudinal direction. Accordingly, similarly to the first scatter prevention sheet 121, the backup sheet 123 is also provided over the entire developer coated region (the region with the developer conveyance ability) of the upstream developing sleeve 111 from the one end to the other end of the developer coated region in the longitudinal direction.

A distal end (a free end 123a) of the backup sheet 123 is preferably arranged on a downstream side of an upstream-side half maximum position of the magnetic pole N2 in the rotational direction of the upstream developing sleeve 111. More preferably, the distal end (the free end 123a) of the backup sheet 123 is arranged on a downstream side of a maximum peak position of the magnetic pole N2 in the rotational direction of the upstream developing sleeve 111.

Even more preferably, the distal end (the free end 123a) of the backup sheet 123 is arranged on a downstream side of a downstream-side half maximum position of the magnetic pole N2 in the rotational direction of the upstream developing sleeve 111.

Here, the maximum peak position of the magnetic pole N2 is a position where magnetic flux density Br of the magnetic pole N2 in a normal direction with respect to the outer circumferential surface of the upstream developing sleeve 111 has a maximum peak value. The upstream-side half maximum position of the magnetic pole N2 is a position that is located on the upstream side in the rotational direction of the upstream developing sleeve 111 among positions, at each of which the value of the magnetic flux density Br of the magnetic pole N2 in the normal direction with respect to the outer circumferential surface of the upstream developing sleeve 111 is a half of the peak value. The downstream-side half maximum position of the magnetic pole N2 is a position that is located on the downstream side in the rotational direction of the upstream developing sleeve 111 among positions, at each of which the value of the magnetic flux density Br of the magnetic pole N2 in the normal direction with respect to the outer circumferential surface of the upstream developing sleeve 111 is a half of the peak value.

In the first exemplary embodiment, the distal end (the free end 123a) of the backup sheet 123 is arranged at a position that is located on the downstream side of the downstream-side half maximum position of the magnetic pole N2 in the rotational direction of the upstream developing sleeve 111 and at which the distal end (the free end 123a) does not contact the photosensitive drum 2. In this way, the first scatter prevention sheet 121 can be suppressed from being lifted by the magnetic brush and can be brought into contact with the magnetic brush of the developer D along the developer D on the upstream developing sleeve 111 to the distal end (the free end 121a) of the first scatter prevention sheet 121 without a clearance.

In order to suppress the deformation of the first scatter prevention sheet 121, a sheet with higher stiffness than the distal end (the free end 121a) of the first scatter prevention sheet 121 is preferably adopted for the backup sheet 123. In the present specification, the stiffness is a measured value that is obtained based on any of various test standards such as Clark stiffness (JIS P 8143), Gurley stiffness (JIS L 1085, JIS L 1096), and Taber stiffness (JIS P 8125-2). Alternatively, in the present specification, the stiffness may be an actual measured value that is obtained from any of various experiments on the Young's modulus (ASTM D882), a tensile elastic modulus (JIS K 7162), and a flexural modulus (JIS K 7171), for example.

In the first exemplary embodiment, the backup sheet 123 is formed of a polyethylene terephthalate (PET) sheet that is approximately 100 μm in thickness.

It is assumed that, in order to suppress the deformation of the first scatter prevention sheet 121, the first scatter prevention sheet 121 is formed of a sheet with high stiffness, such as the PET sheet that is approximately 100 μm in thickness.

In such a case, while the deformation of the sheet, which is caused by the magnetic brush at the magnetic pole N2 of the first magnet roller 131, can be suppressed, the sheet cannot be provided along the developer D of the upstream developing sleeve 111 due to the high stiffness of the sheet. As a result, a region where the sheet does not contact the developer D is formed up to the distal end (the free end 121a) of the first scatter prevention sheet 121, and thus the toner that has been separated and has scattered is possibly accumulated on the distal end (the free end 121a) of the first scatter prevention sheet 121.

In order to solve such an issue, a sheet with low stiffness is preferably used as the first scatter prevention sheet 121 such that the first scatter prevention sheet 121 can be brought into contact with the magnetic brush of the developer D along the developer D on the upstream developing sleeve 111 to the distal end (the free end 121a) of the first scatter prevention sheet 121 without the clearance.

Meanwhile, in order to suppress the deformation of the first scatter prevention sheet 121 by the magnetic brush at the magnetic pole N2 of the first magnet roller 131, a sheet with high stiffness is preferably used as the backup sheet 123 that backs up the first scatter prevention sheet 121.

For this reason, in the first exemplary embodiment, the backup sheet 123 is formed of the PET sheet that is approximately 100 μm in thickness. However, the backup sheet 123 may be formed of a PET sheet that is approximately 50 μm in thickness, preferably approximately 75 μm or more in thickness, and more preferably approximately 100 μm or more in thickness.

In the first exemplary embodiment, the sheet with the high stiffness is used as the backup sheet 123 in order to suppress the deformation of the first scatter prevention sheet 121 by the magnetic brush. However, the method for increasing the stiffness is not limited thereto. For example, a plurality of urethane sheets each of which is approximately 100 μm in thickness and is the same as the urethane sheet used as the first scatter prevention sheet 121 is prepared. Then, the plurality of urethane sheets are superimposed on each other. In this way, a modified example of the backup sheet 123 may have a function to back up the first scatter prevention sheet 121 and thereby increase stiffness in a portion where the magnetic brush is formed at the magnetic pole N2 of the first magnet roller 131.

As it has been described so far, according to the first exemplary embodiment, it is possible to suppress the occurrence of the image failure in the development device having the sheet section (the first scatter prevention sheet 121) that abuts the developer in the region where the developer on the developing sleeve bristles.

In the above-described first exemplary embodiment, the description has been made on the example in which the sheet with the higher stiffness than the first scatter prevention sheet 121 is used as the backup sheet 123 in order to suppress the deformation of the first scatter prevention sheet 121 by the magnetic brush.

In contrast, a second exemplary embodiment differs from the first exemplary embodiment in a configuration of a first scatter prevention sheet since the developing sleeve cover 120 does not have the backup sheet 123. Since a configuration and operational effects other than the above are the same as those in the above-described first exemplary embodiment, the same components will be denoted by the same reference signs, and the description and the illustration thereof will not be made or will be simplified. Hereinafter, a description will be centered on differences from those in the first exemplary embodiment.

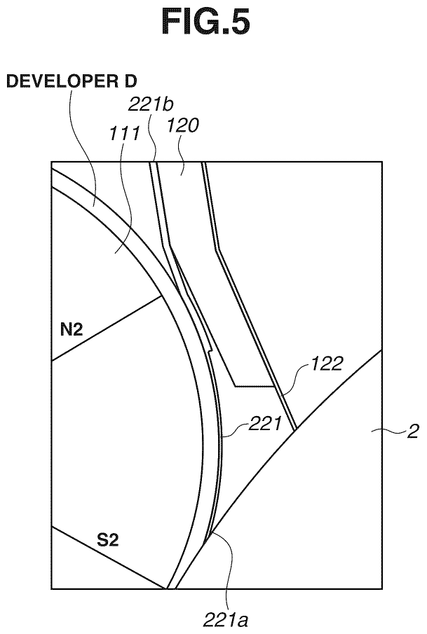

A detailed description will be made on the configuration of the first scatter prevention sheet according to the second exemplary embodiment with reference to FIG. 5. FIG. 5 is a cross-sectional view (an enlarged view) illustrating a configuration around a developing sleeve cover according to the second exemplary embodiment.

As illustrated in FIG. 5, in the second exemplary embodiment, the developing sleeve cover 120 does not have the backup sheet 123. Instead, in the second exemplary embodiment, stiffness of the first scatter prevention sheet 221 is changed between a free end 221a side of the first scatter prevention sheet 221 and a fixed end 221b side thereof in order to suppress deformation of a first scatter prevention sheet 221. More specifically, in order to increase the stiffness on the fixed end 221b side of the first scatter prevention sheet 221, the sheet is thickened on the fixed end 221b side when compared to a distal end of the first scatter prevention sheet 221, which is the free end 221a side of the first scatter prevention sheet 221.

In the second exemplary embodiment, while the distal end (the free end 221a side) of the first scatter prevention sheet 221 is formed of a urethane sheet that is 100 μm in thickness, the fixed end 221b side of the first scatter prevention sheet 221 is formed of a urethane sheet that is 300 μm in thickness. In this way, in the second exemplary embodiment, it is possible to suppress the deformation of the first scatter prevention sheet 221 by the magnetic brush at the magnetic pole N2 of the first magnet roller 131 even when the developing sleeve cover 120 does not have the backup sheet 123.

In the second exemplary embodiment, similar to the first exemplary embodiment, the first scatter prevention sheet 121 is provided over the entire developer coated region (the region with the developer conveyance ability) of the upstream developing sleeve 111 from one end to the other end of the developer coated region in the longitudinal direction.

In the second exemplary embodiment, a region where the stiffness of the first scatter prevention sheet 221 is increased is at least a region from the fixed end 221b of the first scatter prevention sheet 221 to the upstream-side half maximum position of the magnetic pole N2. More preferably, the region where the stiffness of the first scatter prevention sheet 221 is increased is set to a region from the fixed end 221b of the first scatter prevention sheet 221 to the maximum peak position of the magnetic pole N2. Even more preferably, the region where the stiffness of the first scatter prevention sheet 221 is increased is set to a region from the fixed end 221b of the first scatter prevention sheet 221 to the downstream-side half maximum position of the magnetic pole N2. The definitions of the maximum peak position, the upstream-side half maximum position, and the downstream-side half maximum position of the magnetic pole N2 are as described above in the first exemplary embodiment.

In the second exemplary embodiment, the region where the stiffness of the first scatter prevention sheet 221 is increased is set to the region from the fixed end 221b of the first scatter prevention sheet 221 to the downstream-side half maximum position of the magnetic pole N2. That is, the stiffness of the first scatter prevention sheet 221 in the region from the fixed end 221b of the first scatter prevention sheet 221 to the downstream-side half maximum position of the magnetic pole N2 is increased to be higher than the stiffness of the first scatter prevention sheet 221 at the free end 221a of the first scatter prevention sheet 221. In this way, it is possible to suppress the first scatter prevention sheet 221 from being lifted by the magnetic brush.

In the second exemplary embodiment, the stiffness in a region from the downstream-side half maximum position of the magnetic pole N2 to the distal end (the free end 221a) of the first scatter prevention sheet 221 is also reduced. As a result, the first scatter prevention sheet 121 can be brought into contact with the magnetic brush of the developer D along the developer D on the upstream developing sleeve 111 to the distal end (the free end 221a) of the first scatter prevention sheet 221 without the clearance.

As it has been described so far, according to the second exemplary embodiment, it is possible to suppress the occurrence of the image failure in a development device having the sheet section (the first scatter prevention sheet 221) that abuts the developer in the region where the developer on the developing sleeve bristles.

The present disclosure is not limited to the exemplary embodiments described above. Various modifications (including organic combinations of the exemplary embodiments) can be made based on the gist of the present disclosure, and those modifications are not excluded from the scope of the present disclosure.

In the exemplary embodiment described above, as illustrated in FIG. 2, the description has been made on the example in which the development device 1 has two of the upstream developing sleeve 111 and the downstream developing sleeve 112 as the developer bearing members and the first scatter prevention sheet 121 abuts the upstream developing sleeve 111. However, the exemplary embodiment of the present disclosure is not limited thereto. The exemplary embodiment of the present disclosure can also be applied to a development device that has one developing sleeve as the developer bearing member.

In such a modified example, the first scatter prevention sheet 121 abuts the single developing sleeve provided to the development device.

In the exemplary embodiment described above, the description has been made on the example in which the developing sleeve cover 120 has the second scatter prevention sheet 122. The second scatter prevention sheet 122 is provided to have the clearance of approximately 2 to 3 mm from the first scatter prevention sheet 121 and abuts the photosensitive drum 2. Such a modified example may be adopted that the developing sleeve cover 120 has the first scatter prevention sheet 121 (221) but does not have the second scatter prevention sheet 122. A configuration of whether the developing sleeve cover 120 has the second scatter prevention sheet 122 may be appropriately designed according to a degree of scattering of the toner from the first development region A1.

Furthermore, in the exemplary embodiment described above, as illustrated in FIG. 1, the image forming apparatus 100 primarily transfers the toner image that is borne by each of the photosensitive drums 2 (2Y, 2M, 2C, 2K) onto the transfer belt 30. Thereafter, the image forming apparatus 100 brings the sheet P into contact with the transfer belt 30, and secondarily transfers the toner images borne by the transfer belt 30 onto the sheet P. In the exemplary embodiment described above, the description has been made on the thus-configured image forming apparatus 100 as the example. However, the exemplary embodiment of the present disclosure is not limited thereto. The exemplary embodiment of the present disclosure can also be applied to an image forming apparatus that is configured to bring the sheet P into direct contact with the photosensitive drums 2 (2Y, 2M, 2C, 2K) and directly transfer the toner images borne by the photosensitive drums 2 (2Y, 2M, 2C, 2K) onto the sheet P.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-007816, filed Jan. 23, 2024, which is hereby incorporated by reference herein in its entirety.

What is claimed is:

1. A development device comprising:
a developer container configured to accommodate a developer containing toner and a carrier;
a developing rotation member configured to bear and convey the developer in order to develop an electrostatic latent image formed on an image bearing member;
a magnet that is fixed in a non-rotatable manner in the developing rotation member, the magnet having a first magnetic pole and a second magnetic pole, the first magnetic pole being arranged in a closest portion between the developing rotation member and the image bearing member, the second magnetic pole being arranged on an upstream of the first magnetic pole in a rotational direction of the developing rotation member, being adjacent to the first magnetic pole, and being a different pole from the first magnetic pole;
a regulating portion that is provided to oppose the developing rotation member in a non-contact manner and regulates an amount of the developer borne by the developing rotation member;
a cover that is provided to oppose the developing rotation member in a non-contact manner and cover the developing rotation member;
a first sheet that is fixed to the cover, the first sheet being arranged to contact a magnetic brush of the developer that is borne by the developing rotation member; and
a second sheet that is fixed to the cover, at least at a maximum peak position of magnetic flux density of the second magnetic pole in a normal direction with respect to an outer circumferential surface of the developing rotation member, the second sheet being arranged to be superimposed on a first surface of the first sheet that is a surface on an opposite side to a second surface of the first sheet, and the second surface of the first sheet being a surface on a side of contacting the magnetic brush of the developer that is borne by the developing rotation member,
wherein, with respect to the rotational direction of the developing rotation member, a free end of the first sheet is disposed on a downstream of a position where the regulating portion opposes the developing rotation member and on an upstream of the closest portion between the developing rotation member and the image bearing member, and
wherein, with respect to the rotational direction of the developing rotation member, a free end of the second sheet is disposed on the downstream of the position where the regulating portion opposes the developing rotation member and on an upstream of the free end of the first sheet.

2. The development device according to claim 1, wherein the second sheet is arranged to be superimposed on the first surface of the first sheet in a region from an upstream-side half maximum position of the magnetic flux density of the second magnetic pole in a normal direction with respect to the outer circumferential surface of the developing rotation member to a downstream-side half maximum position of the magnetic flux density of the second magnetic pole in a normal direction with respect to the outer circumferential surface of the developing rotation member.

3. The development device according to claim 1, wherein, with respect to the rotational direction of the developing rotation member, the free end of the second sheet is disposed on a downstream of the maximum peak position of the magnetic flux density of the second magnetic pole in the normal direction with respect to the outer circumferential surface of the developing rotation member.

4. The development device according to claim 1, wherein, with respect to the rotational direction of the developing rotation member, the free end of the second sheet is disposed on a downstream of a downstream-side half maximum position of the magnetic flux density of the second magnetic pole in a normal direction with respect to the outer circumferential surface of the developing rotation member.

5. The development device according to claim 1, wherein the first sheet is arranged such that the free end of the first sheet is in contact with the image bearing member.

6. The development device according to claim 1, wherein the second sheet is arranged such that the free end of the second sheet does not contact the image bearing member.

7. The development device according to claim 1, wherein the first sheet is provided over an entire region with a developer conveyance ability of the developing rotation member from one end to another end of the region in a longitudinal direction.

8. The development device according to claim 1, wherein the second sheet is provided over an entire region with a developer conveyance ability of the developing rotation member from one end to another end of the region in a longitudinal direction.

9. The development device according to claim 1, wherein stiffness of the second sheet is higher than stiffness of the first sheet.

10. The development device according to claim 1, wherein the first sheet is a urethane sheet.

11. The development device according to claim 1, wherein the second sheet is a polyethylene terephthalate (PET) sheet.

12. A development device comprising:
a developer container configured to accommodate a developer containing toner and a carrier;
a developing rotation member configured to bear and convey the developer in order to develop an electrostatic latent image formed on an image bearing member;
a magnet that is fixed in a non-rotatable manner in the developing rotation member, the magnet having a first magnetic pole and a second magnetic pole, the first magnetic pole being arranged in a closest portion between the developing rotation member and the image bearing member, the second magnetic pole being arranged on an upstream of the first magnetic pole in a rotational direction of the developing rotation member, being adjacent to the first magnetic pole, and being a different pole from the first magnetic pole;
a regulating portion that is provided to oppose the developing rotation member in a non-contact manner and regulates an amount of the developer borne by the developing rotation member;
a cover that is provided to oppose the developing rotation member in a non-contact manner and cover the developing rotation member; and
a sheet that is fixed to the cover, the sheet being arranged to contact a magnetic brush of the developer that is borne by the developing rotation member,
wherein stiffness of the sheet at a maximum peak position of magnetic flux density of the second magnetic pole in a normal direction with respect to an outer circumferential surface of the developing rotation member is higher than stiffness of the sheet at a free end of the sheet.

13. The development device according to claim 12, wherein, in a region from an upstream-side half maximum position of the magnetic flux density of the second magnetic pole in a normal direction with respect to the outer circumferential surface of the developing rotation member to a downstream-side half maximum position of the magnetic flux density of the second magnetic pole in a normal direction with respect to the outer circumferential surface of the developing rotation member, stiffness of the sheet is higher than the stiffness of the sheet at the free end of the sheet.

14. The development device according to claim 12, wherein, in a region from a fixed end of the sheet to the maximum peak position of the magnetic flux density of the second magnetic pole in the normal direction with respect to the outer circumferential surface of the developing rotation member, stiffness of the sheet is higher than the stiffness of the sheet at the free end of the sheet.

15. The development device according to claim 12, wherein, in a region from a fixed end of the sheet to a downstream-side half maximum position of the magnetic flux density of the second magnetic pole in a normal direction with respect to the outer circumferential surface of the developing rotation member, stiffness of the sheet is higher than the stiffness of the sheet at the free end of the sheet.

16. The development device according to claim 12, wherein the sheet is arranged such that the free end of the sheet is in contact with the image bearing member.

17. The development device according to claim 12, wherein the sheet is provided over an entire region with a developer conveyance ability of the developing rotation member from one end to another end of the region in a longitudinal direction.

18. The development device according to claim 12, wherein the sheet is a urethane sheet.

19. A development device comprising:
a developer container configured to accommodate a developer containing toner and a carrier;
a developing rotation member configured to bear and convey the developer in order to develop an electrostatic latent image formed on an image bearing member;
a magnet that is fixed in a non-rotatable manner in the developing rotation member, the magnet having a first magnetic pole and a second magnetic pole, the first magnetic pole being arranged in a closest portion between the developing rotation member and the image bearing member, and the second magnetic pole being arranged on an upstream of the first magnetic pole in a rotational direction of the developing rotation member, being adjacent to the first magnetic pole, and being a different pole from the first magnetic pole;
a regulating portion that is provided to oppose the developing rotation member in a non-contact manner and regulates an amount of the developer borne by the developing rotation member;
a cover that is provided to oppose the developing rotation member in a non-contact manner and covers the developing rotation member; and
a sheet that is fixed to the cover, the sheet being arranged to contact a magnetic brush of the developer that is borne by the developing rotation member,
wherein a thickness of the sheet at a maximum peak position of magnetic flux density of the second magnetic pole in a normal direction with respect to an outer circumferential surface of the developing rotation member is greater than a thickness of the sheet at a free end of the sheet.

20. The development device according to claim 19, wherein, in a region from an upstream-side half maximum position of the magnetic flux density of the second magnetic pole in a normal direction with respect to the outer circumferential surface of the developing rotation member to a downstream-side half maximum position of the magnetic flux density of the second magnetic pole in a normal direction with respect to the outer circumferential surface of the developing rotation member, a thickness of the sheet is greater than the thickness of the sheet at the free end of the sheet.
